(19) United States
(12) Patent Application Publication
(10) Pub. No.: US 2021/0379813 A1
(43) Pub. Date: Dec. 9, 2021

(54) METHOD AND APPARATUS FOR THE EXPANSION OF CONTAINERS WITH DETERMINING THE GAS PROPORTION

(71) Applicant: KRONES AG, Neutraubling (DE)

(72) Inventor: Andreas VORNEHM, Offenberg (DE)

(21) Appl. No.: 16/957,038

(22) PCT Filed: Dec. 6, 2018
(86) PCT No.: PCT/EP2018/083756

§ 371 Date: Jun. 22, 2020

(30) Foreign Application Priority Data
Dec. 21, 2017 (DE) 10 2017 130 986.1

(51) Int. Cl. B29C 49/78; B29C 49/46

(52) U.S. Cl. CPC B29C 49/783; B29C 49/46; B29C 2049/4664; B29C 2949/78025; B29C 2949/7805; B29L 2031/7158; B29C 2949/78294; B29C 2949/78378; B29C 2949/78563; B29C 2949/7889; B29C 2949/78957; B29C 2949/78109

(57) ABSTRACT

A method for filling and expanding of containers includes the following steps:
Providing an expandable container and particularly an expandable plastic preform;
Filling of the container with a product, wherein the container at least at times during filling is being expanded and wherein the filling is performed by a filling device which is placed against a mouth of the container to be filled and expanded.

According to the process, at least at times a measured value is measured which is characteristic for a gas proportion being located in the filling device.

The present invention relates to an apparatus and a method for the production of containers and in particular for the production of beverage containers. Such apparatuses and methods have long been known from the prior art. Here it has been known so far, first of all, to expand plastic preforms to form plastic bottles for example by means of blow molding machines and to fill them subsequently. As known from a method of a recent state of the art, it is now proposed to form and fill plastic preforms during the same processing step. That means, the transforming of the plastic preform takes place in particular by means of the product to be filled.

In this context, it cannot generally be ruled out that air enters the forming and filling device during the forming and filling process. One the one hand, air which is located in the plastic preform as well as in the area between the plastic preform and the filling unit rises up during and after the forming process of the plastic preform and possibly also enters the forming and filling device. On the other hand, it is possible that air enters the forming and filling unit via the supply line during charging of the forming and filling unit with the product. Such (parasitic) air volumes can interact with the product and hence have a negative impact on the product quality. Additionally, the available volume of the forming and filling unit is reduced. Together with the air proportion in the system, the energy consumption also increases, as with pressure generation this parasitic air has to be compressed and a majority of the energy needed for this purpose is also irreversibly transformed into heat.

Within the scope of the forming and filling process as proposed, it would be advantageous to be able to react in an appropriate way to the respective air volume.

The object of the present invention is to introduce a method for forming and filling of plastic preforms which particularly offers a possibility to reduce disruptive factors due to air in the system. These objects are achieved according to the invention by the subject matters of the independent patent claims. Further advantages and embodiments will become apparent from the dependent claims.

With a method according to the invention for filling and expanding containers and particularly plastic containers, first of all, an expandable container and particularly a plastic preform is provided. This plastic preform is filled with a liquid product, wherein the plastic preform is expanded at least at times during this filling and wherein the filling is carried out by means of a filling device which is placed against a mouth of the container or plastic preform to be filled and expanded.

According to the invention, at least at times a measured value is measured which is characteristic for a gas proportion being located in the filling device.

Preferably, a component of the filling device and particularly a so-called filling nozzle is placed against the mouth rim of the plastic preform in order to fill the same. In this case, this component is particularly preferably placed against this mouth rim in an air-tight manner.

In particular, a gas proportion is determined which is existent in the one of those line paths that, starting from a reservoir for the liquid, lead on to the plastic preform. It is therefore particularly proposed, within the scope of a forming and filling process to be able to determine the gas proportion and in particular the air proportion being existent in the system or in the filling device. In this case, there is preferable a gas proportion and particularly preferable an air proportion in the product to be filled.

In this case, the filling device is particularly understood to be the entire filling device, more precisely that filling and forming device which performs the filling and forming. This filling device preferably also comprises a pressurizing device which provides the pressurized liquid medium. It would also be conceivable to determine the gas proportion at or in this pressurizing device. Additionally, the gas proportion could also be determined in a connecting line which serves to transport the liquid medium from the pressurizing device to the filling unit.

In a preferred method, the filling device and particularly a pressure generating device of this filling device is controlled and/or regulated by using the measured value. In this case, it is possible to move, control and preferably regulate a pressure generating device and preferably a piston device under consideration of this measured value.

Therefore, it would for example be possible on the basis of this information to initiate a ventilation process or to adjust process parameters in a suitable manner. In a preferred embodiment, the product to be filled is provided in particular by means of a pressurizing device and is in particular transported to a filling head. The air volume or the air proportion described here can for example be present in the filling head as well as in the already mentioned pressurizing device.

Hence, the present invention concerns more precisely the idea of determining the air volume being present in the form and filling device, which, as described in more detail below, for example can be carried out via a compressibility of the system volume.

Advantageously, the mentioned measured value is determined in an at least partially and preferably in a substantially enclosed volume area of the filling device. This can be for example a volume section above the contact region of the filling device. In particular, this volume section is delimited by rigid walls in such a way that a product to be filled being present in this volume can be compressed in a defined manner.

In general, the compressibility of a medium is a dimension for the compressibility of this medium and describes how a change in volume influences the pressure being present in the medium. Most of the liquids, in particular products to be filled, have a very low compressibility, whereas air and other gases or gas mixtures normally have a relatively high compressibility. This circumstance can be used, as described in more detail below, in order to draw conclusions on the air proportion in the system.

In this context, it is possible that this volume section is for example closed by closing nozzles and in particular only a one-sided compression is carried out. In this way, a change in volume made by this compression can be detected.

In a preferred embodiment, the measured value is a pressure value or a measured value which is characteristic for a pressure value. In this case, it is for example possible that the pressure or the change in pressure of the medium to be compressed can be determined. This can for example directly be carried out by a pressure measuring device which measures the pressure of the volume to be inspected and in particular also continuously measures the same. Also, this measured value can be a value from which a pressure value can be deduced, like a drive torque, which is applied in order to for example move a respective piston which generates pressure.

In a preferred method, the measured value is a value which is characteristic for a compressibility of a medium, and/or from the measured value a value is determined which is characteristic for the compressibility of the medium.

With the system of the form and filling device described here, the enclosed volume is at least in sections of the process flow precisely determinable, for example since a piston position of a pressurizing device is known. If now a piston device is moved, a change in volume dV is caused as a result. Also, a change in pressure dp occurs which is able to be measured for example by a pressure sensor.

From this data, the air volume of the medium or an air proportion can be determined.

In general, the air volume V₁ is able to be determined on the basis of the following relations:

$${k}_{i} = - \frac{1}{{V}_{i}} \cdot \frac{{dv}_{i}}{{dp}_{i}} ( κ : compressibility )$$

$${V}_{ges} = {V}_{1} + {V}_{2}$$

$${dv}_{ges} = {dv}_{1} + {dv}_{2}$$

$${dp}_{ges} = {dp}_{1} = {dp}_{2} \\ \to {V}_{1} = \frac{{K}_{2} - {K}_{ges}}{{K}_{2} - {K}_{1}} \cdot {V}_{ges}$$

As already mentioned, in addition to the pressure measuring by means of a pressure sensor it is also possible to determine from the drive torque of the servo drive the pressure prevailing in the volume. In this case, preferably a motor control unit measures the motor current within the scope of the drive control, from which in turn the present drive torque can be calculated. From this value, the piston power can be determined, which in turn is proportional to the pressure prevailing in a pressure cylinder.

In addition, it would also be possible to consider the compression modulus for the measurement and calculation of the air volume, which compression modulus is defined as the reciprocal value of compressibility K=1/k. Additionally, it would also be possible to do it vice versa, that is to determine the product volume and subsequently to calculate the gas or air volume from the difference to the total volume.

In a further preferred method, the container is transported along a predefined transport path and at least intermittently during this transport it is expanded and filled. This means in particular that the containers are transported during the whole filling and expanding process and particularly preferably they are transported continuously. Advantageously, the containers are transported along a circular transport path.

In a further advantageous embodiment, the liquid medium is supplied to the container by means of a pressure generating device. In this case, it is possible that this pressure generating device comprises a piston which is being moved relative to a liquid chamber and in particular relative to a chamber which is filled with the product. As already mentioned, this pressure generating device is also part of the filling device.

Advantageously, the filling head mentioned above also has a filling chamber, which is fed by the pressure generating device. In this case, it is possible to measure a pressure difference in the area of the filling head and also in the area of the mentioned pressure generating device.

In a further preferred method, the pressure generating device is controlled by using the measured value as described above. Advantageously, it is possible in this case that the pressure generating device is also controlled by using a gas proportion being determined in this way in the filling medium.

In General, the information about the air volume being present in the system, can be used in several ways. For example, it is possible to use the air volume as an indicator whether a ventilation cycle should be initiated or a ventilation of the system should be controlled.

In addition, this air volume can also serve to optimize the forming and filling process. If there is more air present in the system, it is possible for the trajectory of a piston to be adjusted, resulting in the ideal pressure devolution for the forming and filling process.

In addition, it is also possible for a filling quantity of a filling cylinder to be corrected. An air volume has to be provided during charging of the cylinder so that an appropriate quantity of the product enters the container.

The measurements for the determination of the gas proportion, as described here, are preferably carried out during the process flow and preferably also during a working mode of the apparatus.

With regard to the measurement procedure, it has to be pointed out that different compressibilities of the media are assumed as being existent. The bigger the difference, the easier it is to carry out measurements. For example, the compressibilities of water and air differ from each other by a factor of 20000. As mentioned above, it is preferable for the system and/or a specific volume proportion of the filling device to be closed as firmly as possible during the measurement. If for example diaphragms delimit the closed medium, it is advantageous to make sure that at least during the measurement there is no falsification taking place due to these diaphragms or that these diaphragms are being taken into account while measuring.

The measured value is particularly preferably used by a pressure sensor or a pressure measurement in a filling cylinder and/or a filling head. During measurement, it is also preferable for a travel length of for example a piston device to be considered or to be determined. The same is used to indirectly determine a volume which is also changing due to the changing.

Preferably at least at times a difference in pressure is determined. Hence, for example different pressures at different volumes can be determined. Preferably, at least two pressure values and preferably also at least two volume values are determined. The compressibility can be calculated from the same.

In a further preferable method, a volume of the liquid to be filled is determined inside a predetermined area. This area is preferably, as mentioned above, delimited by walls which are as rigid as possible and the like.

In a further preferred method, a reference measurement is carried out, in particular in a defined volume section and/or based on a defined and/or known medium. Hence, it is conceivable that an initial measurement in a fully vented condition is carried out in order to improve the measurement accuracy. The results thereof can for example also be taken into account for subsequent measurements.

In a further preferred method, at least at times a ventilation of the filling device is performed. In this case it is possible that this ventilation is performed in reaction to a measured gas proportion being for example too high.

In a further preferred method, a plurality of measured values is recorded. A characteristic curve is particularly preferably recorded and in particular a pressure/travel length characteristic curve, wherein the characteristic curve particularly relates to the piston device.

This characteristic curve is particularly compared with a reference curve and/or reference characteristic curve. In this way, it can be determined if there is and if applicable how much (compressed) air or gas there is in the system. If the air proportion or the compressible proportion is too high, it will be possible for example for a rinsing process to be initiated. In addition, it would also be possible that an originally predetermined travel length of a piston will be prolonged, if an excessive gas proportion is determined, in order to compensate the travel path which has been “used up” due to the air compression. Furthermore, it is also possible to carry out a comparison of a measured value with a reference value. Dependent on a measured pressure, it is possible to perform a rinsing or also to set a travel length. In addition, a central pressure generation or a pressure recording would be possible.

In a preferred method, the measured value is used, as mentioned above, for controlling and/or regulating the actual expansion process and in particular for a piston movement for pressure application.

The present invention furthermore relates to an apparatus for filling and expanding plastic parisons, wherein the apparatus comprises a filling device which fills the plastic parisons with a product and at least at times during the filling expands them into plastic containers and in particular into plastic bottles. In this case, the filling device comprises a measuring device which is suitable and intended to at least intermittently determine a measured value which is characteristic for a gas proportion being present in the filling device.

It is therefore also proposed on the device side that a measuring device is provided which at least indirectly allows a determination of the aforementioned gas proportion. In this case, the measuring device can preferably be a pressure measuring device which is suitable and intended to determine a pressure.

Furthermore, the apparatus preferably comprises a processor device which is suitable and intended to determine from at least one measured value a value being characteristic for the gas proportion and in particular the air proportion prevailing in the filling device (inclusive the pressure application device).

The apparatus preferably comprises a transport device, in particular in the form of a rotatable blowing wheel, on which preferably a plurality of transforming stations are arranged. Advantageously, these transforming stations each have stretching rods which are able to be introduced into the containers to be expanded and to be filled, in order to stretch them in the longitudinal direction. Furthermore, these transforming stations preferably each have forming molds, within which the plastic preforms can be expanded into plastic containers. In a further preferred embodiment, at least one transforming station and preferably each single transforming station at least comprises a pressure sensor or a pressure measuring device. This pressure sensor can for example directly be arranged on the filling device, for example in an area where the filling device is being placed against a mouth of the plastic preforms.

In a further preferred embodiment, the apparatus has at least one control device which initiates the pressure controlling. The apparatus preferably comprises one and preferably a plurality of pressure application devices which provide the liquid medium being necessary for the expansion of the containers.

In a further preferred embodiment, the pressure application device has a piston device which is moveable relative to a liquid volume and in particular relative to product volume. In this case, a control device can also be provided which controls the piston movement. In a further advantageous embodiment, the apparatus comprises a position detection device which determines a position of this piston device relative to the liquid volume. In a further advantageous embodiment, the apparatus comprises a drive device for generating the movement of the piston device.

In a preferred embodiment, this is a motorized and in particular an electromotive drive device. In this case, preferably a drive and/or regulation device for a motor current can be provided.

In a further advantageous embodiment, the apparatus comprises a ventilation device in order to allow escape of a gas proportion from a filling path for the product to be filled. In this case, also several ventilation openings can be provided in order to enable ventilation in several areas of the filling path.

Further advantages and embodiments will be apparent from the attached drawings:

Which show:

FIG. 1 a schematic depiction of an apparatus according to the invention;

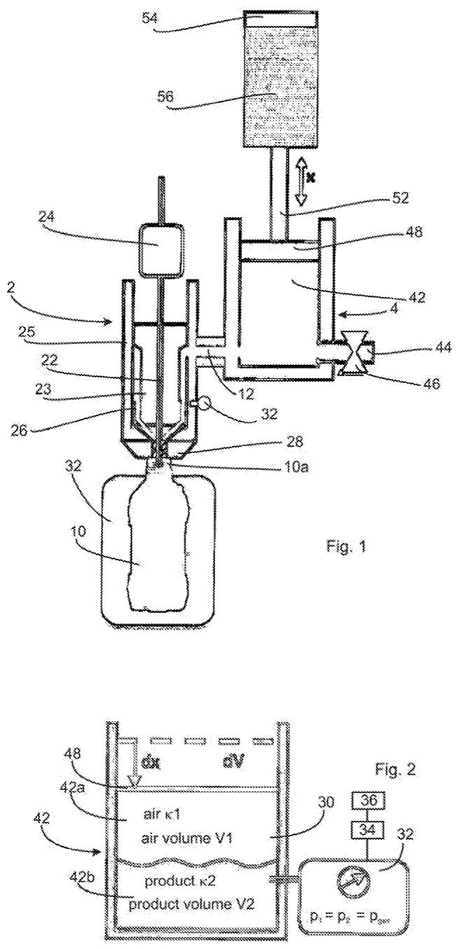

FIG. 2 a depiction by way of illustration of the physical principle of the invention;

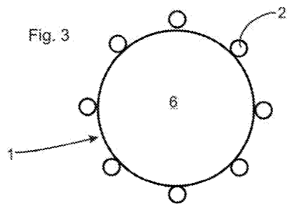

FIG. 3 a further roughly schematic depiction of an apparatus according to the invention.

FIG. 1 shows a roughly schematic depiction of an apparatus according to the invention, more detailed, a transforming station which serves to expand plastic preforms into plastic containers 10 and in particular plastic bottles 10. For this purpose, these filling and transforming stations 2 (above also stated as filling device) comprise a pressure application device 4. This pressure application device 4 has a moveable piston 48 which, more precisely, is movable relative to a receiving volume 42, in which the product to be filled is located. The reference numeral 54 indicates a drive device in order to move this piston device 48. The drive device is in particular an electromotive drive device which moves the piston device in the X direction.

The reference numeral 56 indicates a path measuring device which at least indirectly determines a position of the piston 48 inside the receiving volume 42.

Via a feed line 44 a product to be filled is introduced into the receiving volume 42. Here, a valve 46 is provided which can be opened and closed in order to respectively (for example during a backward movement of the piston device 48) allow liquid and in particular product to be filled to flow into the receiving volume 42.

The product to be filled is transported starting from the receiving volume into the actual filling unit via a feed line 12. In the filling device a receiving volume 26 is provided which is here formed between a closing piston 23 and a peripheral wall 25. Starting from this receiving volume 26 the product to be filled flows via a mouth 10a into the plastic preform and causes in this way also the expansion into the plastic container 10. The reference numeral 28 indicates a contact device, which is able to be placed against the mouth 10a of the plastic preform and thus the liquid can flow into the same. This contact device can be formed as a filling nozzle which in particular is placed against the mouth rim of the plastic preform also in an air-tight manner.

The reference numeral 22 indicates a stretching rod which serves for stretching the plastic preform in the longitudinal direction L. For this purpose, there is also a drive device 24 provided which causes the movement of the stretching rod 22.

FIG. 2 shows a schematic depiction by way of illustration of the physical principals. A receiving volume with liquid 42b and air 42a can here again be seen. Inside of this volume 30 there is an air volume V1 and a product volume V2. The air has a compressibility κ1 and the product a compressibility κ2.

Via a travel length dX a volume difference dV emerges. From the above-stated formula the volume V1 can be deduced in this way which emerges from the compressibilities κ1 and κ2 (which are known), the total compressibility κ_{ges} (which is determined by change in volume and change in pressure) and the total volume. The reference numeral 32 relates to a pressure measuring device which measures in this case the total pressure Pges, which is equal to the individual pressures p1 and p2. More precisely, the pressure measuring device 32 measures the pressure in various positions of the piston 48 and hereof it can, as mentioned above, deduce the pressure measuring curve.

The reference numeral 34 indicates a processor device which determines an air proportion of the medium to be filled and/or the air proportion of the liquid on the basis of the measured values. The reference numeral 36 indicates a control device which controls the apparatus on the basis of this air proportion and controls in particular the drive device 54 (compare FIG. 1).

In addition, the apparatus can also comprise a ventilation device (not shown) which enables ventilation of the apparatus.

FIG. 3 shows a roughly schematically depiction of an apparatus according to the invention 1 for expanding and transforming plastic preforms. In this case, the apparatus has a rotatable carrier 6 on which a plurality of filling and transforming devices 2 are arranged. The plastic preforms can for example be fed via a feed star (not shown) and the transformed and filled containers can be discharged from the plant via a discharge star (also not shown).

The Applicant reserves the right to claim all features disclosed in the application documents as essential to the invention, provided they are novel individually or in combination with respect to the prior art. It is further pointed out that in the individual figures there are features described which per se can be advantageous. The person skilled in the art directly acknowledges that a certain feature described in a figure can also be advantageous without including further features from this figure. Further, the person skilled in the art acknowledges that advantages can also emerge through a combination of features shown in several, individual or different figures.

### LIST OF REFERENCES

2 Filling device
4 Pressure application device
6 carrier
10 container
10a mouth
12 connecting line
22 stretching rod
23 closing piston
25 peripheral wall
26 receiving volume
28 contacting device
30 volume
32 pressure measuring device
34 processor device
42 receiving volume
44 feed line
46 valve
48 piston device
54 distance measuring device
56 drive device
X movement direction of the piston device
L longitudinal direction of the container 10
V1 air volume
V2 product volume
κ1 compressibility of air
κ2 compressibility of product
dV volume difference
p1 pressure
p2 pressure

1: A method for filling and expanding of containers comprising the following steps:
Providing an expandable container and particularly an expandable plastic preform;
Filling of the container with a product, wherein the container at least at times during filling is being expanded and wherein the filling is performed by a filling device which is placed against a mouth of the container to be filled and expanded,
wherein
at least at times a measured value is measured which is characteristic for a gas proportion being located in the filling device.

2: The method according to claim 1, wherein
the filling device and particularly a pressure generating device of the filling device is controlled by using the measured value.

3: The method according to claim 1, wherein
the measured value is determined in a substantially enclosed volume area of the filling device.

4: The method according to claim 1, wherein
the measured value is a pressure value or a measured value which is characteristic for a pressure value.

5: The method according to claim 1, wherein
the measured value is a value which is characteristic for a compressibility of a medium and/or from the measured value a value is determined which is characteristic for a compressibility of the medium.

6: The method according to claim 1, wherein
the container is transported along a predetermined transport path and at least at times during this transport it is expanded and filled.

7: The method according to claim 1, wherein
the liquid medium is supplied to the container by a pressure generating device.

8: The method according to claim 1, wherein
at least at times a pressure difference is measured and/or determined.

9: The method according to claim 1, wherein
a volume of the liquid to be filled is determined inside a predetermined area.

10: The method according to claim 1, wherein
a reference measuring is carried out.

11: The method according to claim 1, wherein
at least at times a ventilation of the filling device is carried out.

12: The method according to claim 1, wherein
a plurality of measured values is recorded.

13: An apparatus for filling and expanding plastic preforms, wherein the apparatus comprises a filling device configured to fill the plastic preforms with a product and to expand the plastic preforms into plastic containers at least at times during the filling, wherein the filling device comprises a measuring device which is configured to determine at least one measured value that is characteristic for a gas proportion being located in the filling device.

14: The apparatus according to claim 1, wherein
the apparatus has a processor device which is configured to determine from at least one pressure value the gas proportion being located in the filling device.

15: The apparatus according to claim 13, wherein
the apparatus has a control device configured to control the filling device and particularly the pressure application device in consideration of the measured value.

16: The apparatus according to claim 14, wherein
the apparatus has a control device configured to control the filling device and particularly the pressure application device in consideration of the measured value.
